(19) United States
(12) Patent Application Publication
(10) Pub. No.: US 2015/0221233 A1
(43) Pub. Date: Aug. 6, 2015

(54) METHOD AND SYSTEM FOR DATA COLLECTION

(71) Applicant: Kodro, Inc., Camden, DE (US)

(72) Inventor: Frédéric Couriol, Paris (FR)

(21) Appl. No.: 14/614,614

(22) Filed: Feb. 5, 2015

Related U.S. Application Data
(60) Provisional application No. 61/935,868, filed on Feb. 5, 2014.

(51) Int. Cl. G09B 19/00

(52) U.S. Cl. CPC G09B 19/00

(57) ABSTRACT

A method for data collection is provided. The method comprises providing a computing device in communication with a server, the computing device presenting server-supplied content to a user, the content being configured to solicit one or more responses from the user, the computing device sending information relating to the responses to the server, and the server assessing aspects of the user's cognitive function based on one or more of the responses.

### CROSS-REFERENCE TO RELATED APPLICATIONS

This application claims the benefit of priority from U.S. Provisional Patent Application No. 61/935,868 filed Feb. 5, 2014, the contents of which are incorporated by reference in their entirety.

### FIELD OF THE INVENTION

The disclosure herein relates to systems for promoting well-being of users. In particular, the disclosure relates to systems for providing cognitive stimulation and reinforcing social ties, especially to the elderly population.

### BACKGROUND OF THE INVENTION

With the increasing aging of segments of the population, tending to the needs of people suffering from cognitive decline is becoming an ever-more relevant issue. Those suffering from mild cognitive impairment or those who are in the early stages of neurodegenerative diseases such as Parkinson's or Alzheimer's are in need of a lot of daily attention. Relatives or non-professional caregivers are typically not prepared to deal with behavioral change which accompanies cognitive decline.

In some circumstances, there are benefits for a senior citizen to remain in his home, even if he is experiencing some degree of cognitive decline. In such circumstances, it is beneficial for him to be able to maintain communication with those outside the home, as well as to participate in activities which stimulate his cognitive facilities.

### SUMMARY OF THE INVENTION

According to one aspect of the presently disclosed subject matter, there is provided a method of collecting data, the method comprising:
providing a computing device in communication with a server;
the computing device presenting server-supplied content to a user, the content being configured to solicit one or more responses from the user;
the computing device sending information relating to the responses to the server;
the server assessing aspects of the user's cognitive function based on one or more of the responses.

The method may further comprise the computing device presenting server-supplied content to a user, the content being selected based on an assessed cognitive function of the user. The cognitive function of the user may be assessed by any method, including, but not limited to, GRS and/or MMSE.

The assessing may be based on the accuracy of a response to a task presented by the computing device.

The assessing may be based on the amount of time it takes the user to complete a task presented by the computing device.

The method may further comprise the server aggregating information based on the responses.

The method may further comprise the server selectively presenting the information to a third party.

The method may further comprise summarizing the information before the presenting.

The information may comprise an assessment of the user's cognitive function based on one or more of the responses.

The information may comprise recommendations.

The content may comprise at least one or more selected from the group including a cognitive exercise, a news item, a short film, music, a book review, a short story, a lifestyle topic (for example relating to a topic including, but not limited to, cooking, exercise, gardening, etc.), health and/or nutritional advice, and a game.

According to another aspect of the presently disclosed subject matter, there is provided a system comprising a computing device and a server configured to carry out the method according to any one of the preceding claims.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1 is a schematic illustration of a system according to the presently disclosed subject matter; and

FIG. 2 is a schematic illustration of a computing device and administration computer of the system illustrated in FIG. 1.

### DETAILED DESCRIPTION OF THE INVENTION

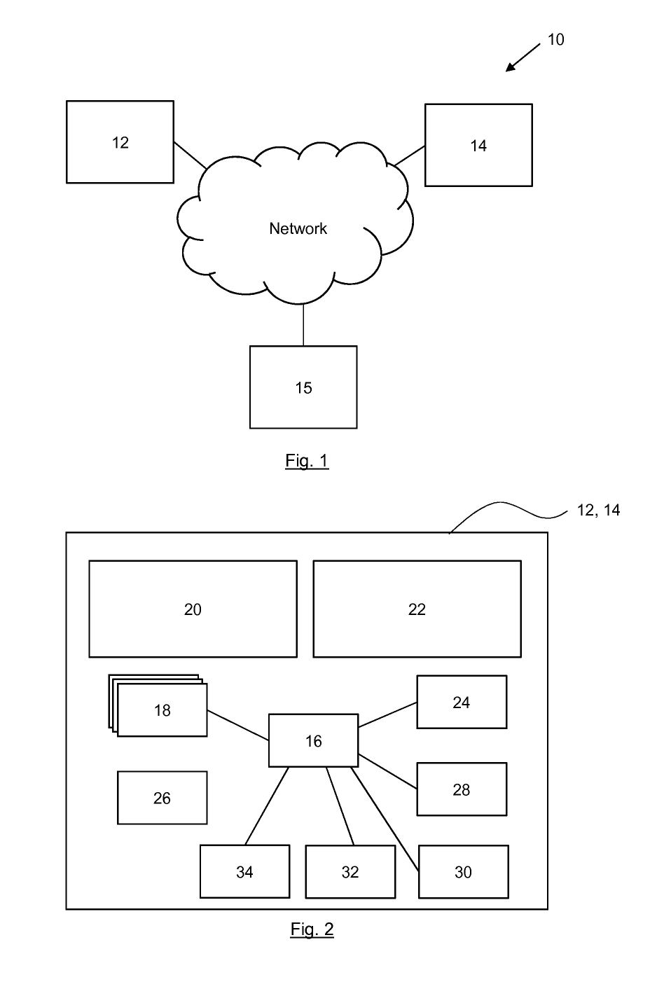

As illustrated in FIG. 1, there is provided a system, which is generally indicated at 10, for cognitive stimulation of a user (the term “user” as used herein refers to both a single user as well as multiple users, either in a single group, in multiple groups, or multiple individuals), and for collecting data about the user, in particular relating to his cognitive function. The system 10 comprises one or more computing devices 12, and an administration computer 14 in communication with the computing device 12. In addition, it may comprise a server 15, remote from the computing devices 12 and administration computer 14, and configured for communication therewith, for example over a public network such as the Internet.

Typically, the user is an elderly person, or someone suffering from a serious loss of global cognitive ability, such as Alzheimer's disease, vascular dementia, frontotemporal dementia, semantic dementia, and dementia with Lewy bodies. However, the system according to the presently disclosed subject matter may be configured for use with any user, mutatis mutandis.

It will be appreciated that herein the specification and claims, the term “cognitive function” is used to refer to a broad range of aspects, including, but not limited to, cognitive function, well-aging, social interactions, etc.

Typically, each user is provided with his own computing device 12. However, it will be appreciated that the computing device 12 can be configured to be shared among any number of users.

The computing device 12 and administration computer 14 may each be any suitable apparatus, including, but not limited to, a tablet computer, a desktop computer, a laptop computer, etc. As illustrated schematically in FIG. 2, each comprises a processor 16, one or more memory modules 18 (which may comprise volatile and/or non-volatile memory), a user-input interface 20, a user-output interface 22, a transceiver 24, and a power source 26. The computing device may comprise other elements, such as an integrated imaging device 28, an audio input output interface 30 (such as an integrated microphone), an audio output interface 32 (such as integrated speakers), one or more ports 34 for connection thereto of external components, etc. The user-input interface 20 and user-output interface 22 may be part of the same element, e.g., a touch-screen may constitute both.

The processor 16 is configured to direct operation of the computing device 12/administration computer 14. Inter alia, it is configured to execute software stored in the memory modules 18. In addition, the processor 16 may be configured to facilitate updating software stored in the memory modules 18, for example by downloading updated software from a remote server via the Internet. In addition, it is configured to receive data for use with the software stored in the memory modules.

The transceiver 24 may be any component configured to facilitate communication by the computing device 12/administration computer 14 with an external network, such as a local- or wide-area network or the Internet. It may comprise one or more of a modem, a wired or wireless network adapter, a Bluetooth adapter, a near-field communications (NFC) adapter, or any other suitable component configured to communicate with an external network.

The imaging device 28 may be any suitable device for digitally capturing an image, for example a digital camera integrated into the computing device 12/administration computer 14, or a digital still or video camera in communication therewith (such as a webcam).

According to the presently disclosed subject matter, the computing device 12 is configured to present pre-selected content to a user, for example as provided by the server 15. The content is selected to as to provide a suitable level of cognitive stimulation to the user, for example as selected by an administrator, as will be described below. In addition, the computing device 12 is configured to solicit responses from the user based on the presented content, and to monitor the user (e.g., with the assistance of the server 15), in particular his level of cognitive function, based on his responses to the content.

The content may comprise one or more different types of content. For example, the content may comprise a cognitive exercise, news item, a short film, music, a book review, a short story, a lifestyle topic (for example relating to a topic including, but not limited to, cooking, exercise, gardening, etc.), health and/or nutritional advice, a game, etc.

Each of the pieces of content may be presented as text, audio, video or the like as well as multimedia combinations of such content as appropriate.

Some of the types of content, e.g., a cognitive exercise or a game, lend themselves naturally to direct feedback by the user. For example, the computing device 12, in presenting a cognitive exercise which requires the user to complete a task, e.g., provide responses to a presented challenge, may be configured to track the types of responses given. In the event that incorrect responses are given by the user, the system 10 may be configured to determine, for example based on the type of error made, that the user may be suffering from cognitive decline. In addition, the system 10 may be configured to determine that the user may be suffering from a cognitive decline even if he provides a correct answer, for example based on the length of time required to provide the answer.

Other types of contents, e.g., short films, book reviews, etc., may not necessarily lend themselves naturally to direct feedback by the user. For such types of context, the computing device 12 may be configured to elicit responses in other ways. For example, it may be configured to require the user to complete a task, e.g., by presenting questions based on the content, wherein the system 10 is configured to determine that the user may be suffering from cognitive decline based on, e.g., types of errors made, the length of time required to respond to the questions, the length of time required to read the content (in cases of text-based content), etc. Optionally, the computing device 12 may utilize user monitoring applications, such as eye tracking software, wearable health monitoring devices, or the like, to provide user feedback where appropriate.

It will be appreciated that in the above cases, the system 10 may be configured to compare parameters of the user's responses (e.g., type of error, amount of time required for a response, etc.) to corresponding parameters from responses given by the user previously to other content of the same type. For example, if the amount of time that a user requires to provide a correct response does not vary significantly over a long period of time, the system 10 may not make a determination of cognitive decline, even if the response is slower than average given the user's age group, cognitive profile, etc.

In addition to analyzing responses of the user to determine whether they may be experiencing a cognitive decline, the system 10 may be configured to adapt the presentation of content via the computing devices 12 based on its assessment of the user. According to one example, a portion of the content, for example that portion which is designed to elicit a response from a user, may be designed such that it can be tailored to different levels of cognitive function, such as requiring the user to recall more or less information relating to the presented content in order to provide a correct response. In such a case, the system 10 may be configured to alter the amount of information required for the user to provide a correct response.

Accordingly, the system 10 may be configured to selectively increase the level of cognitive function required to complete the task associated with the content, such as if it detects that the amount of time the user requires to complete the task is low or declining, for example to keep the user challenged. The system 10 may also present content requiring a higher degree of cognitive function than it has assessed for the user, e.g., in order to verify its assessment and/or to challenge the user in an effort to increase his cognitive function.

The system 10 may also be configured to selectively reduce the level of cognitive function required to complete the task associated with the content, such as if it detects that the amount of time the user requires to complete the task is high or increasing, for example in an effort to reduce potential user frustration thereby keeping him engaged. The system may also present content requiring a lower degree of cognitive function than it has assessed for the user, e.g., in order to provide a rest for the user while still keeping him engaged, albeit at a lower level.

The system 10 may be configured to continually assess the cognitive function of user, based on his responses, in order to adapt it to the user. Accordingly, the cognitive function required to complete tasks may vary among content provided by the system 10 in a single session. In addition, the system 10 may be configured to utilize data relating to the user, for example relating to his responses, from previous sessions in order to adapt the opening content of a session to the user.

The system 10 may be configured to facilitate the user's interaction with others. For example, it may be configured to allow the user to communicate with others via the transceiver 24 of the computing device 12. For example, it may facilitate video chats, text messaging, etc., with others, and these interacting may be integrated into content provided by the system 10. In addition, the system 10 may be configured to facilitate remote assistance to the user by support personnel via the computing device, either in parallel or integrated with content presented thereby.

The system 10 may be further configured to collect and/or aggregate data about the user. For example, it may be configured to collect biographical and/or health information about the user, which may include relevant medical historical information. In addition, it may track the user's usage of the remote computing device 12 to access content and/or complete the associated tasks. According to some modifications, if the user uncharacteristically (as predefined) fails to access the system 10 according to a predefined schedule, the system 10 may be configured to alert a predefined set of people, which may include, but is not limited to, caregivers, family, neighbors, etc. In addition, as mentioned above, the system 10 may be configured to track information relating to the responses to the tasks presented by the computing device, for example response time, accuracy in responses, etc. It may further be configured to prompt the user to provide potentially relevant information regarding his physical state (for example, how he is feeling, if he took a particular medication that day, etc.) and track the information collected from the responses, e.g., with the information relating to the responses.

The system 10 may be configured to use the collected information. For example, it may generate reports regarding the cognitive state of the user, as assessed based on the responses to the tasks. In addition, it may personalize a program of content based on the collected information. The system 10 may be configured to produce a report which summarizes the user's cognitive function, based on its assessment of his responses to the content provided.

The system 10 may be configured to allow an administrator to generate a program for one or more users, in particular which provides a suitable level of cognitive stimulation, for example via the administration computer 14. The system 10 is consequently configured to provide content to the users via their computing devices as per the program. The administration computer 14 may be configured to facilitate the administrator's generating a program based on a schedule, groups, and/or content type.

In connection with setting the schedule, the administration computer may be configured to present a user interface comprising a calendar, e.g., a weekly calendar. The administrator may reserve a time for the program via the user interface. It will be appreciated that the administration computer 14 is typically configured to facilitate scheduling a plurality of different programs on a single calendar.

In addition to presenting the calendar, the administration computer may provide a menu of activities which are available for scheduling during the program. Alternatively, the user may be allowed to select content himself In this connection, the system may be configured to provide and/or suggest content to a user based on content selected by/for the user in the past. The system may allow the user to rate content, and to use the user rating to facilitate the above.

In connection with setting the groups, the administration computer 14 may be configured to allow the administrator to organize users into groups, and to schedule programs for some or all members of a selected group. In this way, an administrator may schedule a program for several users to participate in a group setting, which the administrator or another person may facilitate. The groups may be organized according to any suitable method, for example based on assessed cognitive function (e.g., GRS, MMSE, etc.).

In connection with setting the content type, the administration computer 14 may be configured to provide different content profiles, from among which the administrator may choose one for a given program. The content profiles contain templates of different proportions of content types, based on which the system 10 will build a program. For example, each profile may contain a different percentage of social link content, cognitive content, and relaxation content. The administration computer 14 is configured to allow the administrator to select a content profile which contains a suitable proportion of each type of content, wherein the system selects the specific content based thereon.

For example, the administrator may determine that a particular program should contain a high proportion of social link content, with relatively lower proportions of cognitive and relaxation content. He thus selects an appropriate content profile, and the system 10 creates a program with different types of content, wherein a large proportion thereof is of the social link type, and relatively lower proportions thereof are of the cognitive and relaxation types.

In addition, the administration computer 14 may allow the administrator to select a cognitive domain for the program. Cognitive domains may include, but are not limited to, memory (including working, episodic, and semantic memory), executive function, orientation (including continued/sustained, selective, and divided orientation), language, visual/spatial functions, and wellbeing. When selecting content of the cognitive type for the program, the system 10 may choose content having a strong association with the selected cognitive domain.

In addition to the allowing the administrator to select the content type and cognitive domain, the administrator computer 14 may be configured to allow the administrator to select the duration of the program.

Thus, the administration computer 14 is configured to facilitate an administrator to easily generate one or more programs for one or more groups, and to tailor the type of program to the cognitive and/or social needs of the members of the groups.

Those skilled in the art to which this invention pertains will readily appreciate that numerous changes, variations and modifications can be made without departing from the scope of the invention mutatis mutandis.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the composition or method.

As used herein, the singular form “a”, “an” and “the” may include plural references unless the context clearly dictates otherwise. For example, the term “a compound” or “at least one compound” may include a plurality of compounds, including mixtures thereof

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the disclosure.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

What is claimed is:

1. A method of collecting data, the method comprising:
providing a computing device in communication with a server;
said computing device presenting server-supplied content to a user, said content being configured to solicit one or more responses from said user;
said computing device sending information relating to the responses to the server;
said server assessing aspects of the user's cognitive function based on one or more of said responses.

2. The method according to claim 1, further comprising said computing device presenting server-supplied content to a user, said content being selected based on an assessed cognitive function of the user.

3. The method according to claim 1, wherein said assessing is based on the accuracy of a response to a task presented by said computing device.

4. The method according to claim 1, wherein said assessing is based on the amount of time it takes the user to complete a task presented by said computing device.

5. The method according to claim 1, further comprising said server aggregating information based on said responses.

6. The method according to claim 5, further comprising said server selectively presenting said information to a third party.

7. The method according to claim 6, further comprising summarizing said information before the presenting.

8. The method according to claim 6, wherein said information comprises an assessment of the user's cognitive function based on one or more of said responses.

9. The method according to claim 6, wherein said information comprises recommendations.

10. The method according to claim 1, wherein said content comprises at least one or more selected from the group including a cognitive exercise, a news item, a short film, music, a book review, a short story, a lifestyle topic (for example relating to a topic including, but not limited to, cooking, exercise, gardening, etc.), health and/or nutritional advice, and a game.

11. A system comprising a computing device and a server configured to carry out the method according to claim 1.
